(19) United States
(12) Patent Application Publication
(10) Pub. No.: US 2017/0103466 A1
(43) Pub. Date: Apr. 13, 2017

(54) Risk and Compliance Analytic System

(71) Applicant: Nayeem Syed, Wimbledon (GB)

(72) Inventor: Nayeem Syed, Wimbledon (GB)

(21) Appl. No.: 15/292,185

(22) Filed: Oct. 13, 2016

Related U.S. Application Data
(60) Provisional application No. 62/240,877, filed on Oct. 13, 2015.

(51) Int. Cl. G06Q 40/08; G06Q 50/18

(52) U.S. Cl. CPC G06Q 40/08; G06Q 50/188

(57) ABSTRACT

The present disclosure is directed towards systems and methods for generating a recommendation to on-board a candidate document to an on-line research system, which comprises receiving from an electronic device, a set of data items associated with a candidate document, the candidate document being a document that is a candidate to be made available via the on-line research system and storing the set of data items in a memory. The systems and methods of the present disclosure then automatically analyze the set of data items using a computer program stored in the memory and generate a recommendation as to whether to obtain or not obtain the candidate document. A signal is then generated and transmitted to the electronic device, the signal based upon the recommendation.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to this document: Copyright © 2016 Thomson Reuters.

### TECHNICAL FIELD

This disclosure relates generally to generating risk analytics. More specifically, the disclosure is directed towards a contract risk score tool that can be used to generate related metrics and analytics in a risk profiling system.

### BACKGROUND

Contracts are at the heart of all commerce. When parties engage in a transaction, oftentimes a contact is created and executed that delineates the terms of the transaction that the parties' legal and business representatives have negotiated and ultimately agreed upon. The intention in signing a contract is that all parties will perform as expected. However, as experienced legal and business representatives are aware, oftentimes that is not the case. Whether failure in performance is due to intentional or unintentional acts, the end result is that one or more of the parties may be damaged by the failure to fully perform and realize respective obligations. What an innocent party can actually recover in terms of compensation depends on the terms of the contract which senior risk managers of an organization do not understand well due to the difficulty in controlling contract variation which is either (a) intentional (the contact draftsperson intended the variation which is not in line with the senior risk managers preferences) or (b) unintentional (the contact draftsperson did not actually intend the variation). This is due to a lack of an effective system to manage contract risk. Accordingly, the senior risk managers do not understand the level of aggregate contract risk the organization faces in the event of contact non-performance. This risk should however be well understood so that the senior risk managers can attempt to mitigate that risk or otherwise manage it including through securing adequate insurance. Additionally, in light of more recent regulatory requirements placed on business transactions around the globe, compliance with statutory regulations has become a key consideration in drafting and negotiating agreements. Further, International Accounting Standards require that contract liability is flowing efficiently up into their finance team and then, reflected in financial teens on the balance sheet. However, in most organizations, thousands of contracts are sitting in file cabinets or residing on users' computers which means they exist in isolation from each other. Although contract management systems are there, they are usually simply repositories and offer no way to understand the relative risks in them or their overall contribution to an enterprise's risk profile.

Due to the inherent risk of nonperformance and regulatory noncompliance in an agreement and the subsequent outfall, business entities continue to have an increased need for determining the risk of the nonperformance and regulatory noncompliance for every transaction it engages in, along with the readily apparent factors that influence such risk, as well as unearthing nonobvious factors that may have a similar influence.

Accordingly, there exists a need for automated methods and systems that can quickly and efficiently identify the risk of nonperformance and noncompliance for when entering into a contract. Further there exists a need for automated methods and systems that will generate a suite of analytics that will identify key trends in completed contracts and help determine additional factors that may contribute to the risk of nonperformance and noncompliance.

### SUMMARY

The present disclosure is directed towards systems and methods for determining contract risk. The invention can help organizations (a) define, (b) negotiate, (c) track, (d) analyze and (e) manage contract risk and ultimately, (e) obtain optimal value from their buy-side, sell-side, and other contracts, such as leases and permits. In one aspect, the method includes selecting one or more contract clauses of a contract under review and determining a contract clause risk score for each of the one or more contract clauses, the contract clause risk score based on a contract value, a contract clause liability score, a contract clause variation score and a breach risk score. A contract risk score for the contract is determined based on the contract clause risk score for each of the one or more contract clauses and one or more contract risk analytic values for the contract under review are then generated based on at least one of the contract risk score and the one or more contract clause risk scores. The system can be utilized by organizations to (a) define and manage their target contract risk profile, (b) capture validated contract value and related contract risk data, and (c) become more data-decision driven. By accurately capturing contract value and risk data that can be shared and analyzed, the system can improve risk management, board accountability and corporate governance. The system can help track intentional contract variation and control unintentional contract variation.

According to one embodiment, the contract clause variation score is based on a comparison of a selected contract clause to an associated model contract clause. In one embodiment, the breach risk score is a score identifying a likelihood of breach of the contract clause, the likelihood of breach of the contract clause based on at least one of a comparison to a likelihood of breach of the associated model contract clause. According to one embodiment, the contract clause liability score is a score identifying the liability that the selected contract clause exposes a contractual party to and is based on a comparison to the associated model contract clause.

In one embodiment, the method further includes identifying one or more risk relationships for the contract under review based on at least one of the one or more the contract risk analytics, the contract risk score and the one or more contract clause risk scores. These scores then readily enable the conducting of various statistical approaches such as scenario and sensitivity analysis based on verified at source data.

According to one embodiment, the method further includes automatically generating one or more new contracts based on at least one of the one or more the contract risk analytics, the contract risk score and the one or more contract clause risk scores. The system can help streamline the contracting process by enabling the contract manager define acceptable negotiation parameters and associated risks. The system defines an explicit set of rules using a contract risk wizard and profiles a suite of standard terms and conditions for enterprise-specific risk appetites. The system also uses the contract risk wizard to profile contract negotiations, in real time, with inbuilt controls as to which language or terms can be changed, by whom or with whose authority in the organization. The system can track all changes and negotiation history and enable direct comparisons with other negotiations of the same type of provision. The system will ensure contracts do not include language or terms without relevant authority. The system accelerates the overall time it takes to conclude contracts. The system reduces lawyer time to review contracts. The system reduces senior approver review time with escalations or for governance.

According to one embodiment, the one or more contract risk analytic values comprises an identification of a given contract clause of the contract under review that contributes the most to the overall contract risk score. In one embodiment, the one or more contract risk analytic values comprises a risk ratio value, wherein the risk ratio value is a comparison of the contract value per the contract risk score of the contract under review to a contract value per a contract risk score of a second contract under review.

A system, as well as articles that include a machine-readable medium storing machine-readable program code for implementing the various techniques, are disclosed. Details of various embodiments are discussed in greater detail below.

Additional features and advantages will be readily apparent from the following detailed description, the accompanying drawings and the claims.

### BRIEF DESCRIPTION OF THE DRAWINGS

FIG. 1 is a schematic depicting an exemplary computer-based risk profiling system for determining contract and compliance risk;

FIG. 2 is a flow diagram illustrating an exemplary computer-implemented method for determining contract and compliance risk for a contract in a risk profiling system;

FIG. 3 is a flow diagram illustrating an exemplary computer-implemented method for determining contract and compliance risk for a contract clause in a risk profiling system;

FIG. 5 is an exemplary screen diagram of an exemplary graphical representation of the contract and compliance risk user interface;

FIG. 6 is an exemplary screen diagram of an exemplary graphical representation of the contract and compliance risk user interface;

FIG. 7 is an exemplary screen diagram of an exemplary graphical representation of the contract and compliance risk user interface;

FIG. 8 is an exemplary screen diagram of an exemplary graphical representation of the generated analytics corresponding to the generated risk profiles;

FIG. 9 is an exemplary screen diagram of an exemplary graphical representation of the generated analytics corresponding to the generated risk profiles;

FIG. 10 is an exemplary screen diagram of an exemplary graphical representation of the generated analytics corresponding to the generated risk profiles;

FIG. 11 is an exemplary screen diagram of an exemplary graphical representation of the generated risk profiles; and

FIG. 12 is an exemplary screen diagram of an exemplary graphical representation of the generated analytics corresponding to the generated risk profiles.

Like reference symbols in the various drawings indicate like elements.

### DETAILED DESCRIPTION

In the following description, reference is made to the accompanying drawings that form a part hereof, and in which is shown by way of illustration specific embodiments in which the disclosure may be practiced. It is to be understood that other embodiments may be utilized and structural changes may be made without departing from the scope of the present disclosure.

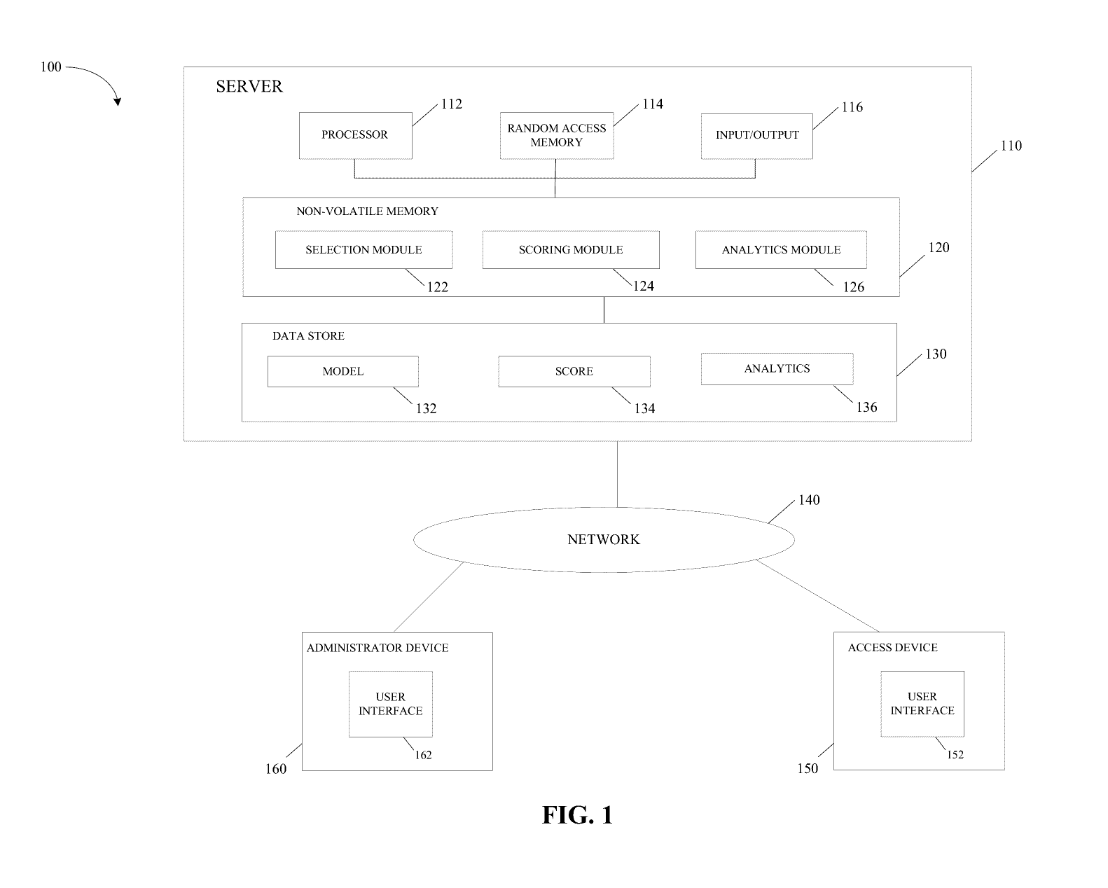

Turning now to FIG. 1, an example of a suitable computing system 100 within which embodiments of the disclosure may be implemented is presented. The computing system 100 is only one example and is not intended to suggest any limitation as to the scope of use or functionality of the disclosure. Neither should the computing system 100 be interpreted as having any dependency or requirement relating to any one or combination of illustrated components.

For example, the present disclosure is operational with numerous other general purpose or special purpose computing consumer electronics, network PCs, minicomputers, mainframe computers, laptop computers, as well as distributed computing environments that include any of the above systems or devices, and the like.

The disclosure may be described in the general context of computer-executable instructions, such as program modules, being executed by a computer. Generally, program modules include routines, programs, objects, components, data structures, loop code segments and constructs, and other computer instruction known to those skilled in the art that perform particular tasks or implement particular abstract data types. The disclosure can be practiced in distributed computing environments where tasks are performed by remote processing devices that are linked through a communications network. In a distributed computing environment, program modules are located in both local and remote computer storage media including memory storage devices. Tasks performed by the programs and modules are described below and with the aid of figures. Those skilled in the art may implement the description and figures as processor executable instructions, which may be written on any form of a computer readable media.

In one embodiment, with reference to FIG. 1, the computing system 100 includes a server device 110 configured to include a processor 112, such as a central processing unit (“CPU”), random access memory (“RAM”) 114, one or more input-output devices 116, such as a display device (not shown) and keyboard (not shown), non-volatile memory 120, all of which are interconnected via a common bus 118 and controlled by the processor 112. According to one embodiment, the server 110 is part of an on-line research system. In another embodiment, the server 110 is separate from the on-line research system and transmits one or more candidate documents to be stored within the on-line research system.

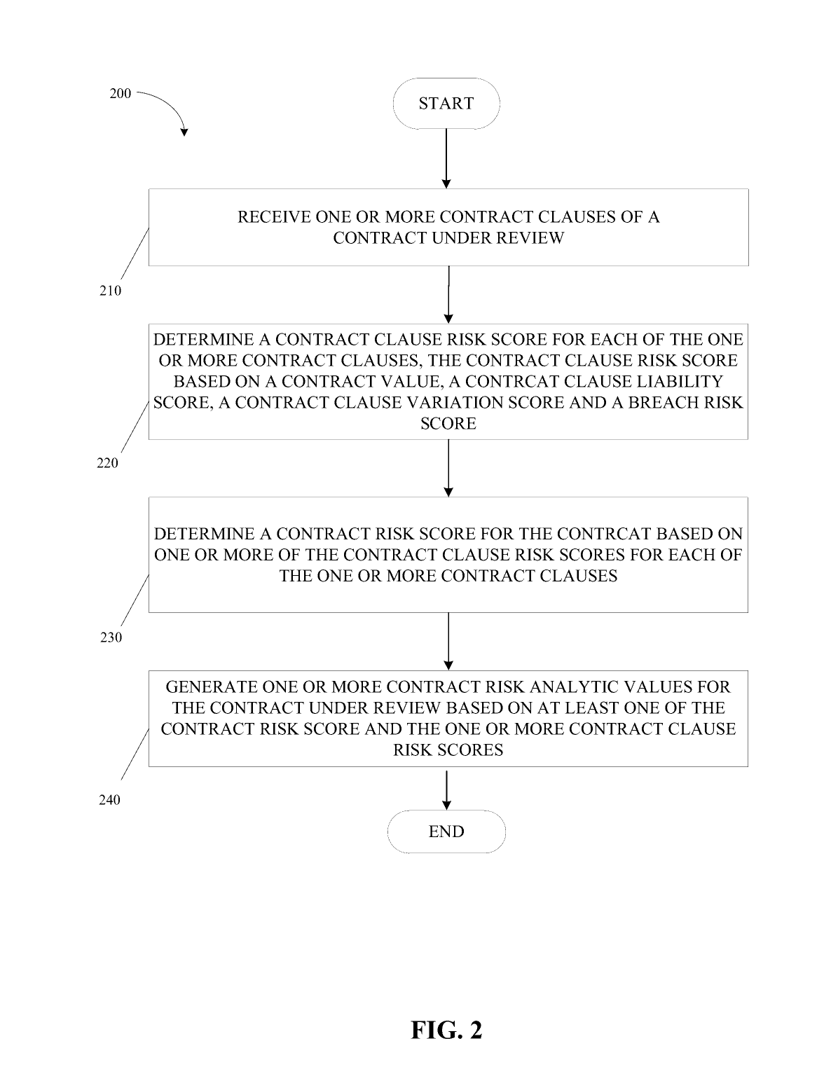

As shown in the FIG. 1 example, in one embodiment, the non-volatile memory 120 is configured to include a selection module 122, a scoring module 124, and an analytics module 126. The selection module 122 is configured to receive contracts and contract clause for analysis, select contracts and contract clauses to be analyzed from a set of available documents and select model contract and contract clauses for use in analyzing contacts and contract clauses. The scoring module 124 is configured to analyze and score contacts and contract clauses, as well as the corresponding compliance of each, in view of model contracts and contract clauses. The analytics module 126 is configured to generate analytics surrounding the determined risk and compliance scores for the analyzed contracts and contract clauses. Additional details of modules 122, 124 and 126 are discussed in connection with FIGS. 2-13.

As shown in FIG. 1, in one embodiment, a network 150 is provided that can include various devices such as routers, server, and switching elements connected in an Intranet, Extranet or Internet configuration. In one embodiment, the network 150 uses wired communications to transfer information between an access device 150, the server device 110, a data store 130 and an administrator device 160. In another embodiment, the network 150 employs wireless communication protocols to transfer information between the access device 150, the server device 110, the data store 130 and the administrator device 160. For example, the network 150 may be a cellular or mobile network employing digital cellular standards including but not limited to the 3GPP, 3GPP2 and AMPS family of standards such as Global System for Mobile Communications (GSM), General Packet Radio Service (GPRS), CDMAOne, CDMA2000, Evolution-Data Optimized (EV-DO), LTE Advanced, Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN). The network 150 may also be a Wide Area Network (WAN), such as the Internet, which employs one or more transmission protocols, e.g. TCP/IP. As another example, the network 150 may employ a combination of digital cellular standards and transmission protocols. In yet other embodiments, the network 150 may employ a combination of wired and wireless technologies to transfer information between the access device 160, the server device 110, the data store 130 and the content servers 170 and 180.

The data store 130 is a repository that maintains and stores information utilized by the before-mentioned modules 122, 124 and 126. In one embodiment, the data store 130 is a relational database or a series of relational databases. In another embodiment, the data store 130 is a directory server, such as a Lightweight Directory Access Protocol (“LDAP”), In yet another embodiment, the data store 130 is an area of non-volatile memory 120 of the server device 110 containing one or more databases.

In one embodiment, as shown in the FIG. 1 example, the data store 130 includes a model database 132, a score database 134 and analytics database 136. According to one embodiment, the model database 132 maintains a set of model contracts and contract clauses that are made available to the selection module 122 and are used by the scoring model 124 to generate one or more score for analyzed contracts and contract clauses. The score database 134, in one embodiment, maintains the repository of risk and compliance scores for the analyzed contracts and contracts clauses generated by the scoring model 124. In one embodiment, the analytics database 136 maintains the repository of analytics generated by the analytic module 128 utilizing the repository of risk and compliance scores for the analyzed contracts and contracts clauses maintained in the score database 134.

Although the data store 130 shown in FIG. 1 is connected to the network 150, it will be appreciated by one skilled in the art that the data store 130 and/or any of the information shown therein, can be distributed across various servers and be accessible to the server 110 over the network 150; be coupled directly to the server 110; be configured as part of server 110 and interconnected to processor 112, RAM 114, the one or more input-output devices 116 and the non-volatile memory 120 via the common bus 118; or be configured in an area of non-volatile memory 120 of the server 110.

The access device 150, according to one embodiment, is a mobile device having a graphical user interface (“GUI”) 152, a digital signal processor with an application module (not shown), internal and external storage components (not shown), a power management system (not shown), an audio component (not shown), audio input/output components (not shown), an image capture and process system (not shown), RF antenna (not shown) and a subscriber identification module (SIM) (not shown). According to another embodiment, the access device 160, is a general purpose or special purpose computing device comprising the graphical user interface (“GUI”) 152, as well as a processor, transient and persistent storage devices, an input/output subsystem, a bus to provide a communications path between components comprising the general purpose or special purpose computer, and a web-based client application, such as a web browser, which allows a user to access the server 110. Examples of web browsers are known in the art, and include ell-known web browsers such as such as Microsoft® Internet Explorer®, Google Chrome™, Mozilla Firefox® and Apple® Safari®.

The administrator device 160, according to one embodiment, is a general purpose or special purpose computing device comprising a graphical user interface (“GUI”) 162, as well as a processor, transient and persistent storage devices, an input/output subsystem, a bus to provide a communications path between components comprising the general purpose or special purpose computer, and a web-based client application, such as a web browser, which allows a user to access the server 110. Examples of web browsers are known in the art, and include well-known web browsers such as such as Microsoft® Internet Explorer®, Google Chrome™, Mozilla Firefox® and Apple® Safari®. According to another embodiment, administrator device 160 is a mobile device having the GUI 162, a digital signal processor with an application module (not shown), internal and external storage components (not shown), a power management system (not shown), an audio component (not shown), audio input/output components (not shown), an image capture and process system (not shown), RF antenna (not shown), and a subscriber identification module (SIM) (not shown).

Further, it should be noted that the system 100 shown in FIG. 1 is only one embodiment of the disclosure. Other system embodiments of the disclosure may include additional structures that are not shown, such as secondary storage and additional computational devices. In addition, various other embodiments of the disclosure include fewer structures than those shown in FIG. 1. For example, in one embodiment, the disclosure is implemented on a single computing device in a non-networked standalone configuration. Data input and requests are communicated to the computing device via an input device, such as a keyboard and/or mouse. Data output, such as the computed significance score, of the system is communicated from the computing device to a display device, such as a computer monitor.

Turning now to FIG. 2, an exemplary method 200 for determining contract and compliance risk is disclosed. In the illustrated embodiment shown in FIG. 2,

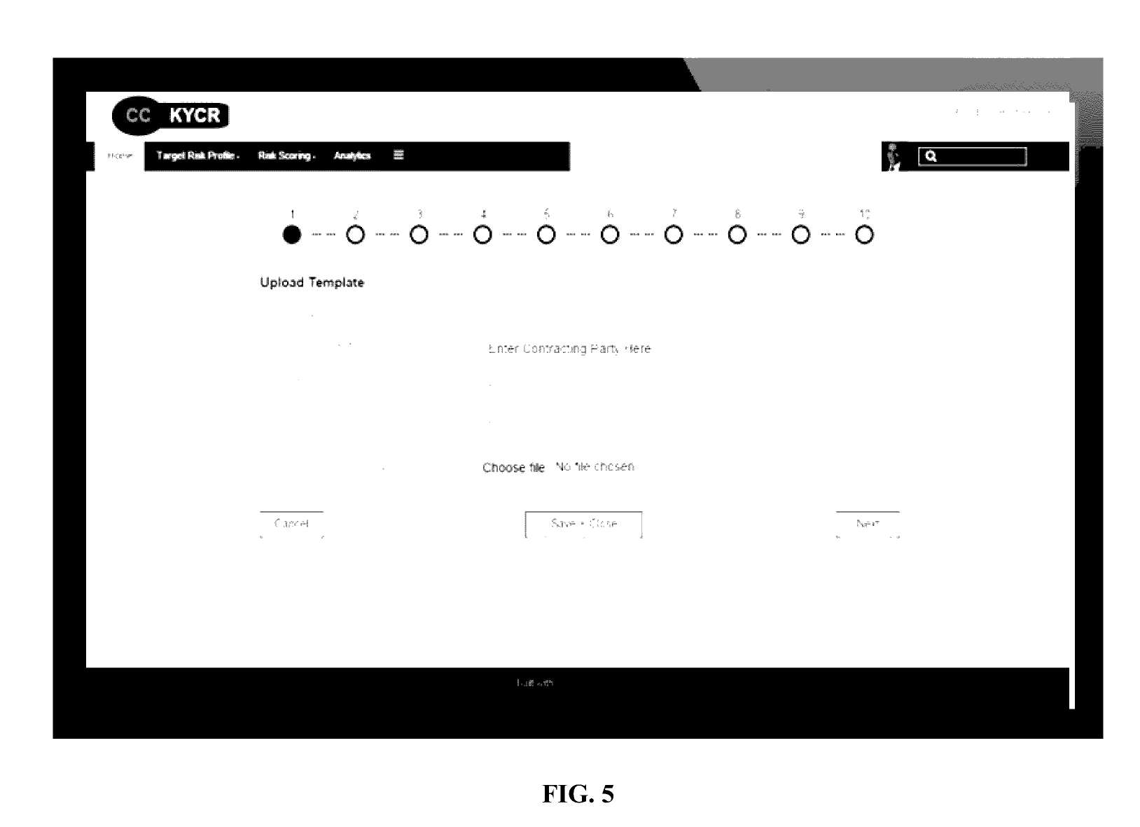

One or more contract clauses of a contract under review are received by the selection module 122 of system 100 referenced in FIG. 1, step 210. According to one embodiment, a user uploads a draft contract comprising one or more contract clauses for processing through the risk profiling system 100 at the access device 150, which is received by the selection module 122 via the network 140. For example, a user submits, via the user interface 152, an electronic copy of a proposed sales contract comprising multiple contract clauses, such as (i) Scope of Services, (ii) Delivery of Services, (iii) Service Level Credits, (iv) Supplier Warranties, (v) Indemnities, (vi) Customer's Right to Terminate, (vii) Assignment, (viii) Losses of Customer Beneficiaries, and (ix) Jurisdiction, received from a supplier for analysis to system 100. FIG. 5 depicts an exemplary user interface whereby a user can upload a contract template for analysis and enter additional information such as contracting party, jurisdiction and contract type.

At step 220, a contract clause risk score is determined by the scoring module 124 for each of the one or more contract clauses, the contract clause risk score being based on a contract value, a contract clause liability score, a contract clause variation score and a breach risk score. In particular, the contract clause risk score is determined subject to the following Equation 1,

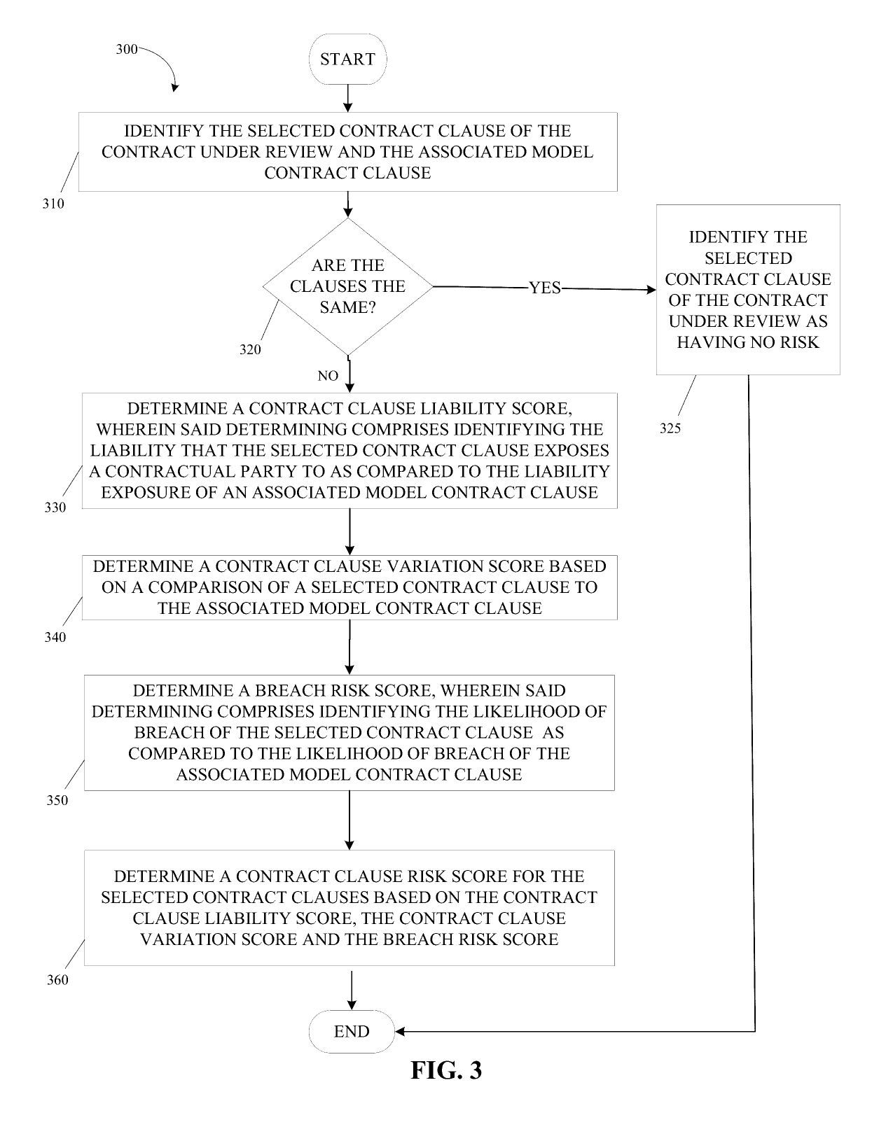

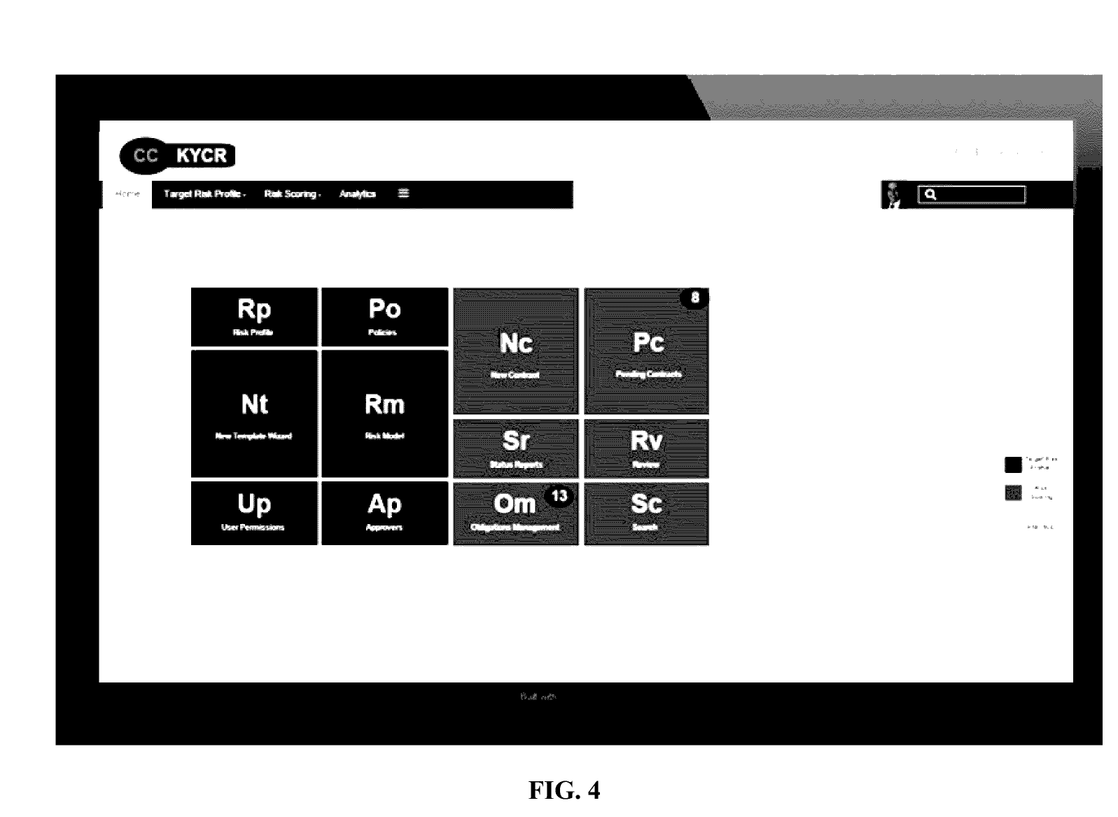

Clause Risk Scoreₙ=Breach Risk Scoreₙ×Clause Liability Scoreₙ, (Eq. 1)

where (i) the Breach Risk Scoreₙ is a percentage of the likelihood of breach of contract clauseₙ and is based on the contract clause variation score of contract clauseₙ and the incremental likelihood of breach of contract clauseₙ and (ii) the Clause Liability Scoreₙ is the total liability for the contract clauseₙ based upon one or more of the total liability for the loss of profit, loss of revenue, loss of anticipated savings, loss of data, third party liability, damage to the customer's physical property or IT systems, will non-performance or deliberate misconduct by supplier's personnel and deliberate contract abandonment by supplier. Additional details surrounding the determination of an individual contract clause score will be discussed in more details in connection with FIG. 3.

A contract risk score is then determined by the scoring module 124 for the contract based on one or more of the contract clause risk scores for each of the one or more contract clauses step 230. In particular, the contract risk score is determined subject to the following Equation 2,

$$Contract Risk Score = \frac{\begin{matrix}{\sum }_{i = 1}^{n} Clause Risk {Score}_{1} + \\ Clause Risk {Score}_{2} + … + Clause Risk {Score}_{n}\end{matrix}}{Contract Value} \qquad ( Eq . 2 )$$

where Clause Risk Scoreₙ for each contract clause is determined subject to Equation 1 and the Contract Value is the potential value of the contract during the term of the contract, such as for example, the potential revenue to be generate during the term of a sales contract. In this fashion, the comparison of the risk of contracts can be compared by a common measure of unit of risk per dollar of income.

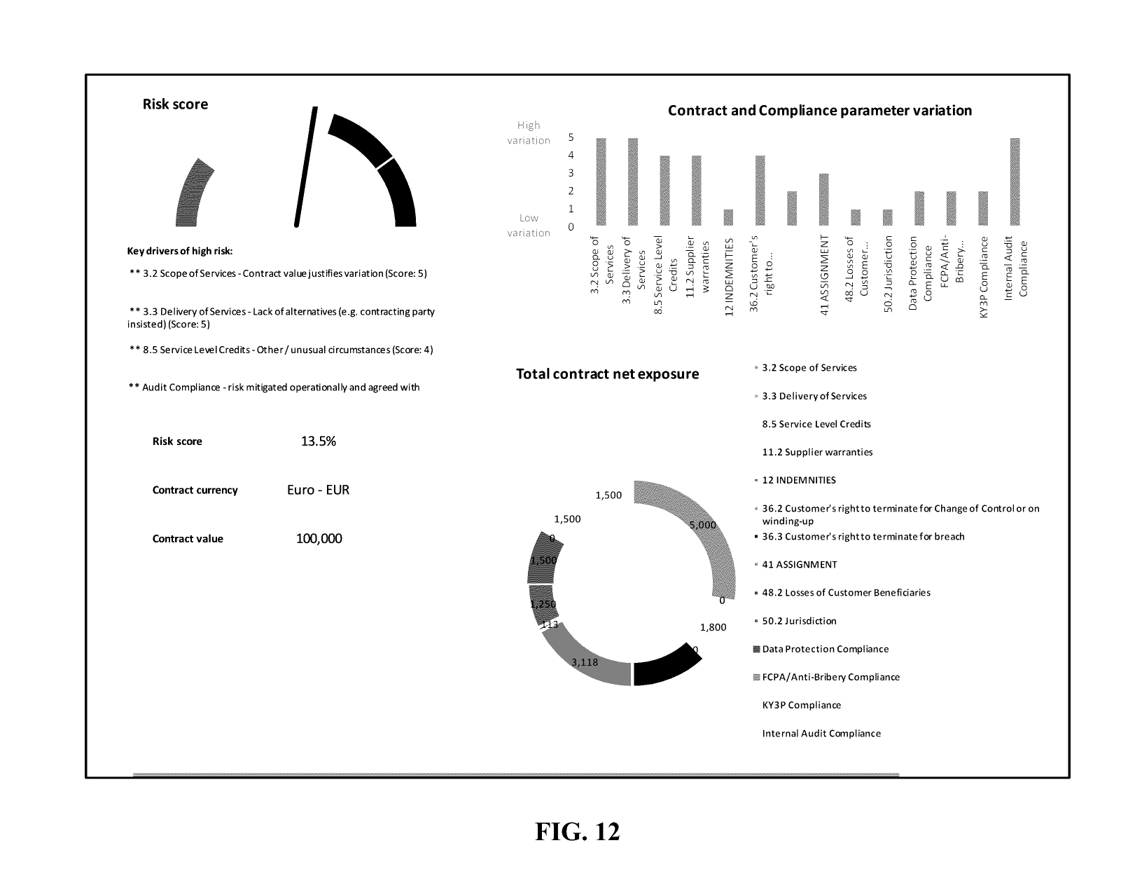

At step 240, one or more contract risk analytic values for the contract under review is generated by the analytics module 128 based on at least one of the contract risk score and the one or more contract clause risk scores and is subsequently stored in the analytics database 136. According to one embodiment, a multitude of analytics can be generated, including analytics specific to the contract under review and its individual contract clauses, as depicted in FIG. 12. Additional analytics can also be generated directed to wholesale analytics for the universe of contracts or one or more subsets of the repository of contracts engaged by an entity. The following is exemplary list of analytics that can be generated by the analytics module 128 using the contract risk score and the one or more contract clause risk scores as the cornerstones for the wide range of analytics.

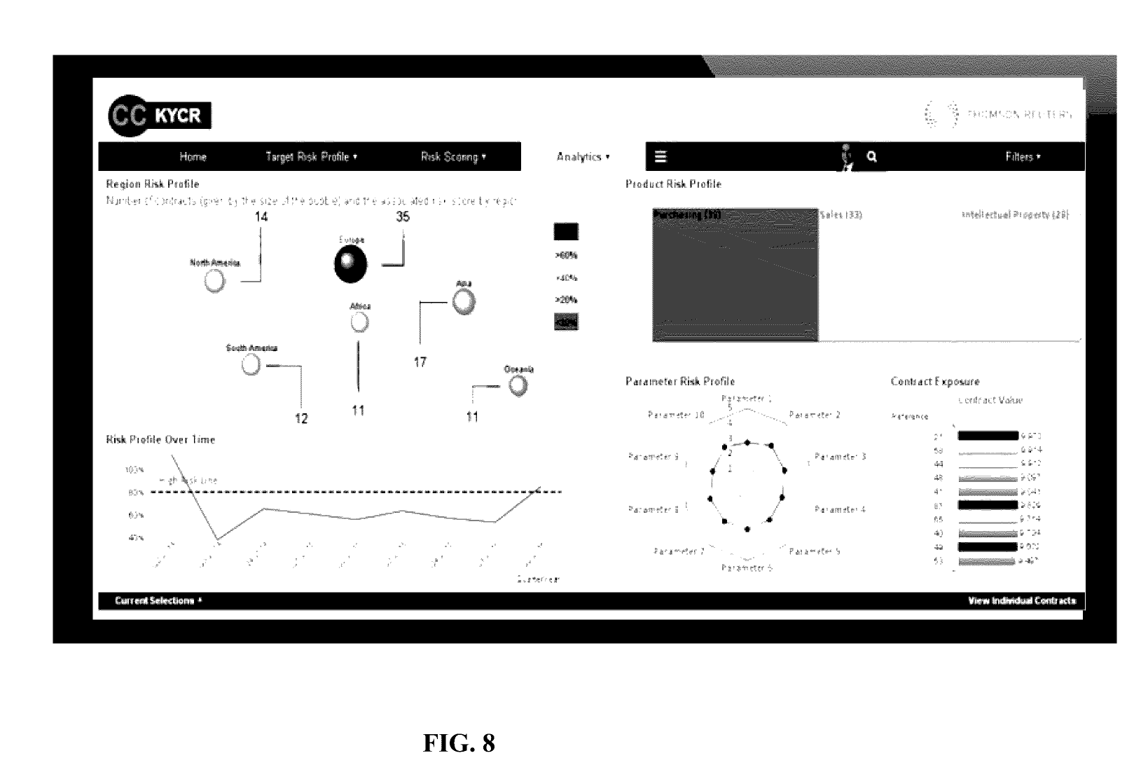

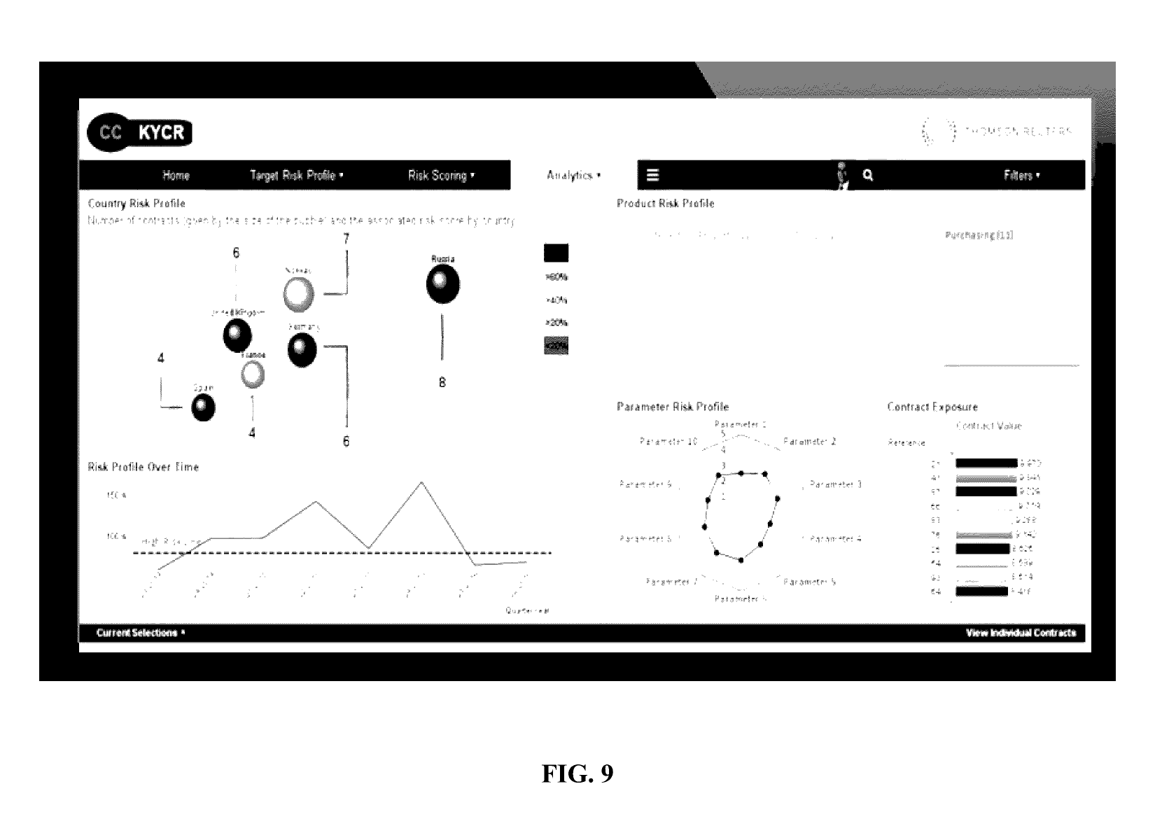

Legal Analytics:
Geographic Risk Profile that demonstrates global and regional aggregate risk and risk variation of contract clauses and overall contracts by geographic location. In one example, global and regional heat-map diagrams are generated by the analytics module 126, which show (x) volume, (y) aggregate risk and (z) risk variation by geography for all sales contracts within a defined period for a global company and users can visually observe in which regions the greatest concentration of risk resides. Exemplary embodiments as presented by the on the user interface 152 of the access device 150 are depicted in FIGS. 8 and 9.
Product Risk Profile that demonstrates the aggregate risk and risk variation by revenue generating product. In one example, bar graphs and pie charts are generated which show (x) volume, (y) aggregate risk and (z) risk variation according to each revenue generating product in which users can visually observe in which products the greatest concentration of risk resides. Exemplary embodiments are depicted in FIGS. 8 and 9.
Parameter Risk Profile that demonstrates the aggregate risk and risk variation across one or more of the following segmentations (a) contract type, (b) business unit and (c) region. In one example, spider and bar graphs which show (x) volume and (y) aggregate risk and (z) risk variation across the aforementioned segmentations for all sales contracts within a defined period for a global company and in which users can visually observe where the greatest variation has appeared. Exemplary embodiments are depicted in FIGS. 8 and 9.
Contributor Risk Profile that demonstrates which contracts contribute most to the overall risk profile across the following segmentations: (a) contract type, (b) business unit and (c) region, which in one example is depicted as a bar graph and visually represents which contracts have a disproportionate weighting on the overall risk.
Gross Risk over Time Profile that demonstrates timeline showing the difference between a target risk profile and actual risk of an enterprise aggregate risk, as well as risk variation across the following segmentations: contract type, (b) business unit and (c) enterprise. In this way, users can visually observe when risk is reaching unacceptable levels and which contracts are contributing most to the level. Exemplary embodiments are depicted in FIGS. 8 and 9.

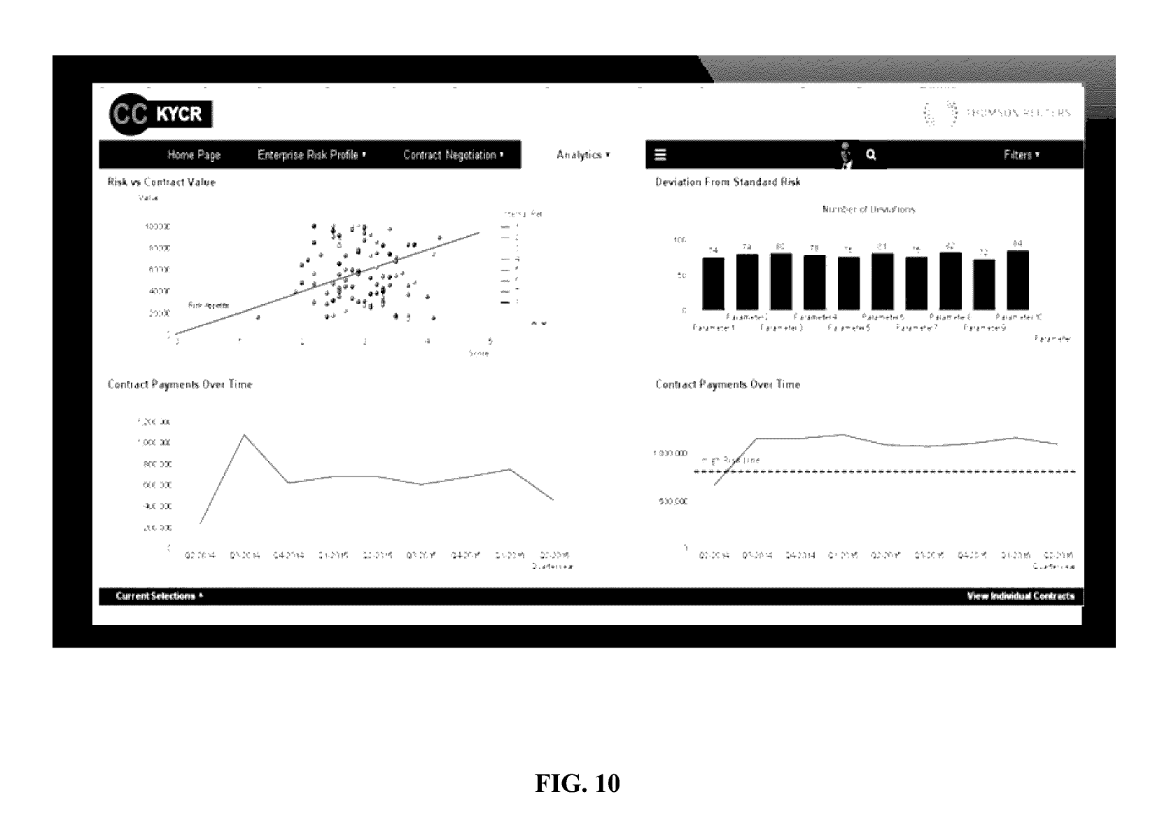

Financial Analytics:
Financial Indicators that demonstrate the financial trend of contracts that satisfy defined parameters, including specified contract type, business unit, region, jurisdiction, currency, contract value or value range. In one example, this accomplished across the following segmentations: (a) contract type, (b) business unit and (c) region, in which bar graphs and heat-maps can depict which contracts fulfill the parameters and which are contributing most to the profile. In another example, scatter plot diagram showing a segmented group of contracts across any two of the financial indicators parameters. For example, Risk versus Contract Risk: Contract Value (y) and Risk Score (x) matrix. Exemplary embodiments are depicted in FIG. 10.
Contract Payments over Time Profile, which according to one embodiment, includes a timeline that depicts earnings across the following segmentations: (a) contract type, (b) business unit and (c) enterprise. In one example, users can visually observe the projected revenue profile and identify which contracts are contributing most to the profile. The Contract Payments over Time Profile can also be compared to the Gross Risk over Time Profile, providing a deeper dive of the data such as payments as compared to risk for an enterprise. Exemplary embodiments are depicted in FIG. 10.

Compliant Contracting and Financial Regulatory Compliance Analytics:
Compliance Indicators that demonstrate the compliance trend of contracts that that satisfy defined parameters, including specified contract type, business unit, region, and jurisdiction. In one example, this accomplished across the following segmentations: (a) contract type, (b) business unit and (c) region, in which bar graphs and heat-maps can depict which contracts fulfill the parameters and which are contributing most to the risk profile.
Data Protection Compliance Indicators that demonstrate the data protection compliance trend of contracts that that satisfy defined parameters, including (i) general obligation to comply with applicable data protection legislation, (ii) requirement that the supplier will only process, use and disclosure in accordance with agreement, with consent or law, (iii) requirement that the supplier will not transfer of personal data outside relevant jurisdiction, (iv) requirement that the supplier will take reasonable security arrangements, (v) requirement that the supplier will allow access by authorized personnel only, (vi) requirement that the supplier will maintain accurate and complete data, (vii) requirement that the supplier will retain for defined period and return at end, (viii) requirement that the supplier will immediately notify if any obligation breached and (ix) requirement that the supplier will indemnify if any obligation breached. In one example, users can visually observe compliance across the relevant jurisdictions mapped to the contract (territories performance) and further identify which are contributing most to the risk profile.
FCPA/Anti-bribery Compliance Indicators, which in one example, include bar graphs and heat-maps that depict the contracts that fulfill inputted compliance parameters, including requirements that the (i) Supplier will not engage in any conduct or activity that constitutes a conflict of interest under applicable federal, state or local laws, rules and regulations (e.g. the UK Bribery Act 2010), (ii) no elected or public sector official, officer or employee that has directly or indirectly a personal interest in contract shall be involved in any decision regarding contract, (iii) supplier will not promise, offer or transfer anything of value to secure the contract, (iv) supplier will ensure all employees abide by applicable policies and regulations, (v) supplier will immediately notify if any obligation breached and (vi) supplier will indemnify if any obligation breached.
Third Party Risk (KY3P) Indicators, which in one example, include bar graphs and heat-maps that depict the contracts that fulfill inputted compliance parameters, including (i) 4th Party/Sub-contract Compliance: Supplier will maintain consistency with its own suppliers and contactors with customer's policies and procedures, agreed service levels, applicable laws, regulations, and ethical standards; (ii) Information Security: Supplier will maintain sufficient controls to protect the integrity of customer's information; (iii) Business Continuity: Supplier has effective redundancy procedures to maintain its services due to business disruption; (iv) Financial Viability: Supplier has financial can continue to provide services at acceptable levels; (v) Physical Security: Supplier will maintain proper security measures to prevent unauthorized access to its facilities; and (vi) Legal/Regulatory: Supplier has necessary licenses to remain compliant with domestic and international laws and regulations.
Internal Audit Indicators, which in one example, include bar graphs and heat-maps that depict the contracts that fulfill inputted internal audit parameters across the following segmentations: (i) supplier will comply with prevention of bribery laws and customer policies; (ii) supplier will maintain records and allow post contract audit; (iii) supplier will perform in accordance with anti-discrimination laws and customer diversity policies; (iv) supplier will perform in accordance with Human Rights Act 1998 and customer policies; (v) supplier will allow set-off and recovery of sums due under different contracts; (vi) supplier will maintain insurance to specified levels; (vii) supplier will perform in accordance with health and safety legislation and customer policies; and (viii) supplier will perform in accordance with data privacy laws and customer policies.

It is to be understood that the number and types of analytics generated are not limited to the number and types of scores described herein, which are being disclosed herein as exemplary, and that other analytics may be determined by the analytics module 126.

Turning now to FIG. 3, an exemplary computer-implemented method 300 for determining a contract clause risk score is disclosed. In step 310 of the embodiment shown in FIG. 3, the selection module 122, giving received a contract to review, selects the contract clause of the contract to be reviewed. In one embodiment, the selection is performed by having received an instruction from the access device 150, in response to the user having identified the “Indemnities” clause as the contract clause to be analyzed. In another embodiment, the score database 134 maintains a set of rules that identifies the contract clauses that are to be reviewed and are to be executed by the selection module 122. For example, the set of rules would indicate that that all contract clauses that mention the terms “service level agreements (SLAs)”, “warranties,” “indemnities,” and “losses,” and any variations thereto, are to be analyzed and the selection module 122 would identify such contracts using known techniques in the art such as keyword matching.

Additionally, the selection module 122 identifies an associated model contract clause from the model database 132. In one embodiment, the model database 132 maintains the model contract clauses in a categorical schema, which categorizes contract clauses according to type and title and the selection module 122 interrogates the categorical schema to identify an associated model contract clause using title and keyword matching techniques as are known in the art or other matching techniques, such as those supported by artificial intelligence methodologies. In another embodiment, the associated model contract clause is identified by the user. In yet another embodiment, the associated model contract clause is selected from combination of human and computer selections.

Returning to FIG. 3, at step 320, the selection module 122 compares the contract clause under review to the associated model contract clause, which will serves as the baseline language, in order to identify whether the two contract clauses are the same. If they are indeed the same, further analysis is not needed and the selected contract clauses of the contract under review is identified as having no risk, step 325. If the contract clauses are not the same, then process flow continues to step 330.

At step 330, the scoring module 124 next determines a contact clause liability score, wherein said determining comprises identifying the liability that the selected contract clause exposes a contractual party to as compared to the liability exposure of an associated model contract clause, step 330. In one example, a contract clause under review provides a liability cap for a loss of revenue at fifty thousand dollars while the associated model contract clause provides a liability exposure cap of twenty thousand dollars. As a result of the higher liability exposure, a contract clause liability score is generated. According to one embodiment, the contract clause liability score is the difference between the liability cap of the contract clause under review and the associated model contract clause. In another embodiment, the contract clause liability score is the liability cap of the contract clause under review, assuming the cap is higher than that of the associated model contract clause; assuming the liability cap is lower, the contract clause liability score may be set to zero.

At step 340, a contract clause variation score is determined by the scoring module 124 based on a comparison of a selected contract clause to the associated model contract clause. For example, the text of an indemnity associated model contract clause, which serves as the baseline language, may read as follows,
The Supplier shall indemnify and hold the Customer and the Customer Group Companies harmless against all Losses arising out of: (a) death, personal injury or damage to real or tangible property; (b) any allegations of infringement of a third party's intellectual property, including all costs associated with the defense of any legal action within the Courts or administrative office worldwide, (c) fraud, willful default or negligence in relation to this Agreement; and/or (d) any penalties and/or interest charges imposed by a competent tax authority arising out of the error or omission to Sales Taxes,
   as compared to an indemnity contract clause under review, which reads as follows,
The Supplier shall indemnify and hold the Customer and the Customer Group Companies harmless against all Losses arising out of: (a) death, personal injury or damage to real or tangible property; (b) fraud, willful default or negligence in relation to this Agreement; and/or (c) any penalties and/or interest charges imposed by a competent tax authority arising out of the error or omission to Sales Taxes,
   In one embodiment, the scoring module 124 compares the two contract clauses and determines that the clauses are indeed different in that the contract clause under review does not provide for and is silent with regard to an intellectual property indemnity. The identification of the differences between the two contract clauses may be accomplished by a variety of ways, including known parsing and keyword matching techniques, artificial intelligence language processing, human review or any combination thereof.

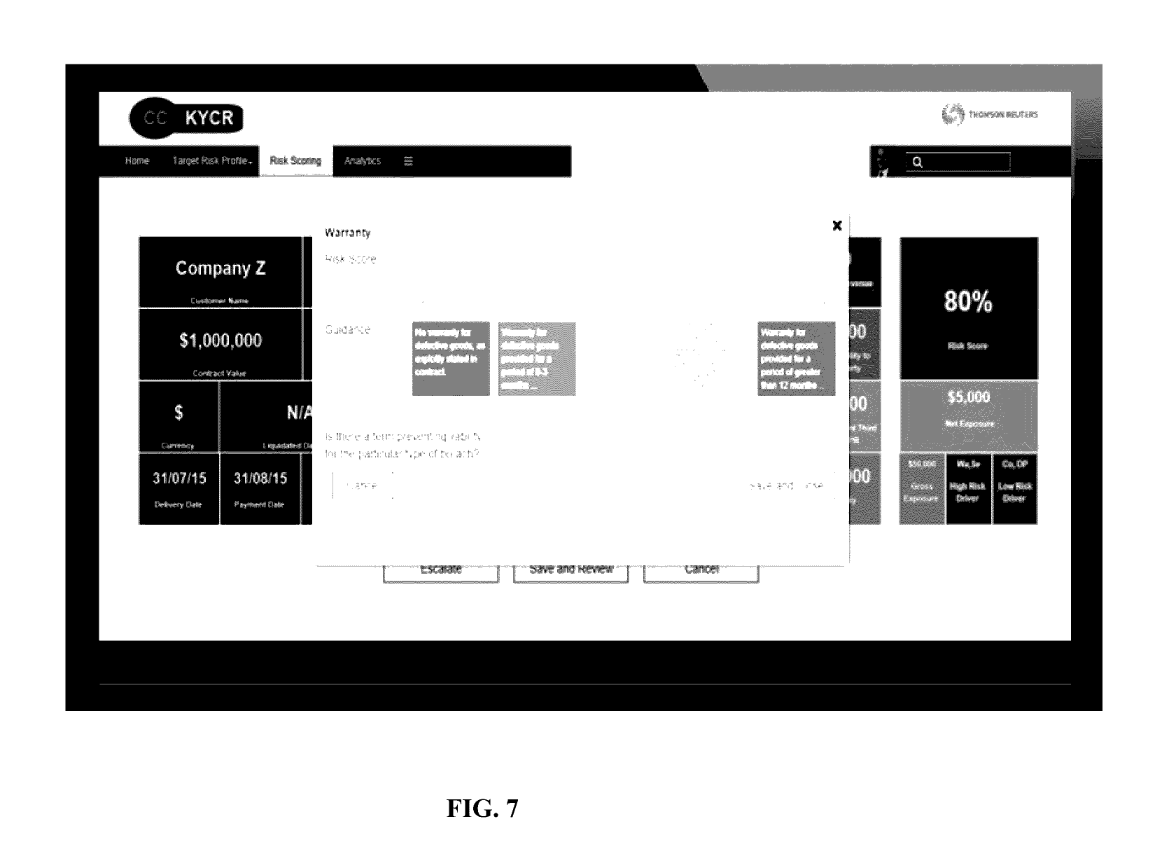

Once any differences are identified between a selected contract clause under review and the associated model contract clause, a contract clause variation score is assigned to the contract under review. In one embodiment, the scoring module 124 interrogates the score database 134 and locates a set of rules maintained therein that correlates a variation score, such as numbering scale of a score of 1 for slightly variable to a score of 5 for highly variable, to key characteristics or concepts that are absent from the clause under review. For example, for a warranty clause, a set of rules may include: (i) Score 5 if there is no warranty of defective goods explicitly stated in the contract, (ii) Score 4 if a warranty for defective goods if provided for a period of 1 to 3 months, (iii) Score 3 if a warranty for defective goods if provided for a period of 3 to 6 months, (iv) Score 2 if a warranty for defective goods if provided for a period of 6-12 months and (v) Score 1 if a warranty for defective goods if provided for a period of greater than 12 months. In one embodiment, the variation scoring is accomplished by the scoring module 124 performing known parsing and keyword matching, and language processing techniques as is known in the art. In another embodiment, human review is used to assist in determining the contract variation score as depicted in the user interface of FIG. 7.

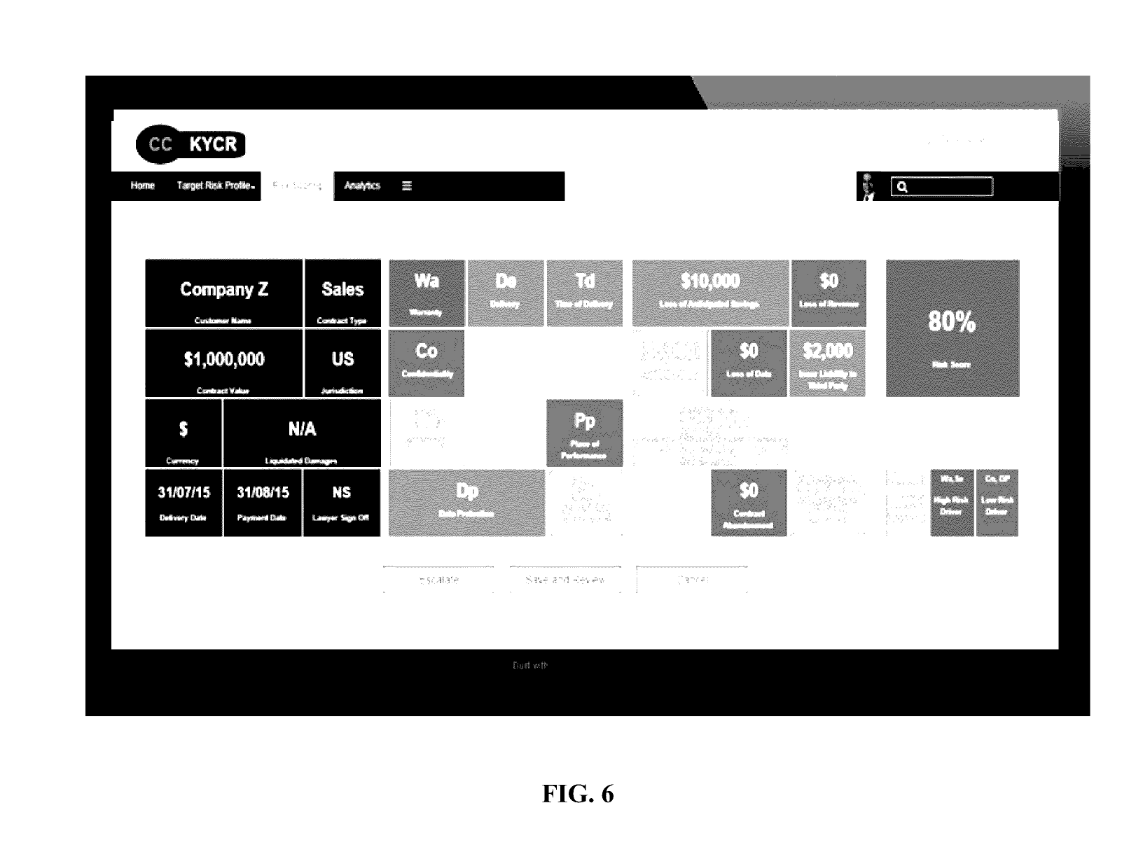

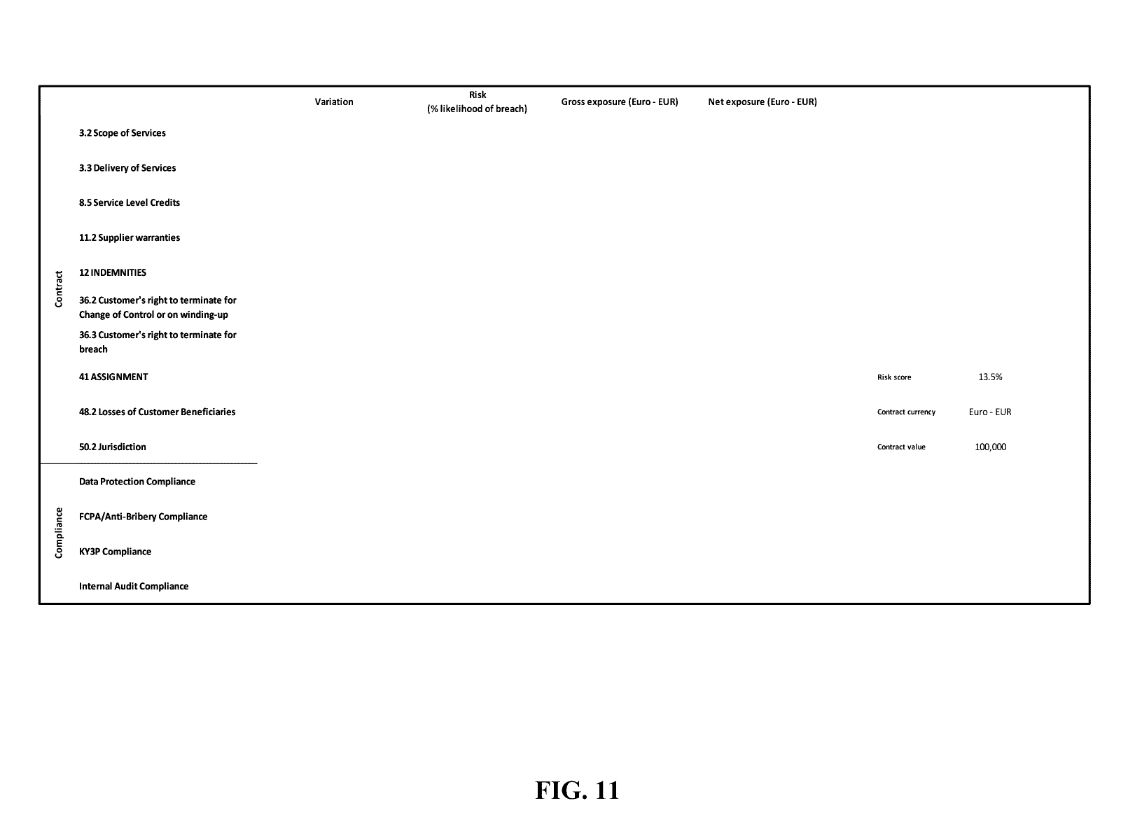

Returning to FIG. 3, a breach risk score is the determined by the scoring module 124, wherein said determining comprises identifying the likelihood of breach of the selected contract clause as compared to the likelihood of breach of the associated model contract clause, step 350. In one embodiment, the breach risk score is a percentage likelihood of breach of contract clause, which is defined and maintained in the score database 134, for example, according to industry standards, and then adjusted by the contract variation score, determined in step 340. In another embodiment, the breach risk score can be automatically adjusted by third party data, such as trend data or regulatory or compliance data maintained by third party resources, which reflects more recent variations in the legal fields and finance markets that may alter the industry standards. In yet another embodiment, options to adjust the breach risk score can be provided for selection, such options being based on third party data, such as trend data or regulatory or compliance data maintained by third party resources previously mentioned, which reflects more recent variations in the legal fields and finance markets that may alter the industry standards. At step 360, a contract clause risk score is determined for the selected contract clauses based, the contract clause liability score, the contract clause variation score and the breach risk score. As discussed previously in connection with Equation 1, the breach risk score, which is adjusted based on the contract clause variation score, is multiplied by the contract liability score in order to determine an overall contract clause risk score. FIGS. 6 and 11 depicts exemplary screen diagram of an graphical representation of the generated risk profiles, which lists the determined contract clause variation score for each listed contract clause, as well as the breach risk score for each, the gross exposure value or clause liability score for each, and the overall contract clause risk score or next exposure for each.

FIGS. 1 through 12 are conceptual illustrations allowing for an explanation of the present disclosure. It should be understood that various aspects of the embodiments of the present disclosure could be implemented in hardware, firmware, software, or combinations thereof. In such embodiments, the various components and/or steps would be implemented in hardware, firmware, and/or software to perform the functions of the present disclosure. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the disclosure as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present disclosure to a single embodiment, as other embodiments are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific embodiments so fully reveals the general nature of the disclosure that others can, by applying knowledge within the skill of the relevant art(s), readily modify and/or adapt for various applications such specific embodiments, without undue experimentation, without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present disclosure have been described above, it should be understood that they have been presented by way of example, and not as limitations. It would be apparent to one skilled in the relevant art(s) that various changes in form and detail could be made therein without departing from the spirit and scope of the disclosure. Thus, the present disclosure should not be limited by any of the above-described exemplary embodiments, but should be defined only in accordance with the following claims and their equivalents.

What is claimed is:

1. A method for determining contract risk, the method comprising:
selecting one or more contract clauses of a contract under review;
determining a contract clause risk score for each of the one or more contract clauses, the contract clause risk score based on a contract value, a contract clause liability score, a contract clause variation score and a breach risk score;
determining a contract risk score for the contract based on the contract clause risk score for each of the one or more contract clauses; and
generating one or more contract risk analytic values for the contract under review based on at least one of the contract risk score and the one or more contract clause risk scores.

2. The method of claim 1 wherein the contract clause variation score is based on a comparison of a selected contract clause to an associated model contract clause.

3. The method of claim 1 wherein the breach risk score is a score identifying a likelihood of breach of the contract clause, the likelihood of breach of the contract clause based on at least one of a comparison to a likelihood of breach of the associated model contract clause.

4. The method of claim 1 wherein the contract clause liability score is a score identifying the liability that the selected contract clause exposes and contractual party to and is based on a comparison to the associated model contract clause.

5. The method of claim 1 further comprising identifying one or more risk relationships for the contract under review based on at least one of the one or more the contract risk analytics, the contract risk score and the one or more contract clause risk scores.

6. The method of claim 1 further comprising automatically generating one or more new contracts based on at least one of the one or more the contract risk analytics, the contract risk score and the one or more contract clause risk scores.

7. The method of claim 1 wherein the one or more contract risk analytic values comprises an identification of a given contract clause of the contract under review contributes the most to the contract risk score.

8. The method of claim 1 wherein the one or more contract risk analytic values comprises a risk ratio value, wherein the risk ratio value is a comparison of the contract value per the contract risk score of the contract under review to a contract value per a contract risk score of a second contract under review.

9. Non-transitory computer readable media comprising program code stored thereon for execution by a programmable processor to perform a method for determining contract risk, the computer readable media comprising:
program code for selecting one or more contract clauses of a contract under review;
program code for determining a contract clause risk score for each of the one or more contract clauses, the contract clause risk score based on a contract value, a contract clause liability score, a contract clause variation score and a breach risk score;
program code for determining a contract risk score for the contract based on the contract clause risk score for each of the one or more contract clauses; and
program code for generating one or more contract risk analytic values for the contract under review based on at least one of the contract risk score and the one or more contract clause risk scores.

10. The computer readable media of claim 9 wherein the contract clause variation score is based on a comparison of a selected contract clause to an associated model contract clause.

11. The computer readable media of claim 9 wherein the breach risk score is a score identifying a likelihood of breach of the contract clause, the likelihood of breach of the contract clause based on at least one of a comparison to a likelihood of breach of the associated model contract clause.

12. The computer readable media of claim 9 wherein the contract clause liability score is a score identifying the liability that the selected contract clause exposes and contractual party to and is based on a comparison to the associated model contract clause.

13. The computer readable media of claim 9 further comprising program code for identifying one or more risk relationships for the contract under review based on at least one of the one or more the contract risk analytics, the contract risk score and the one or more contract clause risk scores.

14. The computer readable media of claim 9 further comprising program code for automatically generating one or more new contracts based on at least one of the one or more the contract risk analytics, the contract risk score and the one or more contract clause risk scores.

15. The computer readable media of claim 9 wherein the one or more contract risk analytic values comprises an identification of a given contract clause of the contract under review contributes the most to the contract risk score.

16. The computer readable media of claim 9 wherein the one or more contract risk analytic values comprises a risk ratio value, wherein the risk ratio value is a comparison of the contract value per the contract risk score of the contract under review to a contract value per a contract risk score of a second contract under review.

17. A system for determining contract risk, the system comprising:
a server including a processor and memory storing instructions that, in response to receiving a request from an access device, cause the processor to:
select one or more contract clauses of a contract under review;
determine a contract clause risk score for each of the one or more contract clauses, the contract clause risk score based on a contract value, a contract clause liability score, a contract clause variation score and a breach risk score;
determine a contract risk score for the contract based on the contract clause risk score for each of the one or more contract clauses; and
generate one or more contract risk analytic values for the contract under review based on at least one of the contract risk score and the one or more contract clause risk scores.

18. The system of claim 17 wherein the contract clause variation score is based on a comparison of a selected contract clause to an associated model contract clause.

19. The system of claim 17 wherein the breach risk score is a score identifying a likelihood of breach of the contract clause, the likelihood of breach of the contract clause based on at least one of a comparison to a likelihood of breach of the associated model contract clause.

20. The system of claim 17 wherein the contract clause liability score is a score identifying the liability that the selected contract clause exposes and contractual party to and is based on a comparison to the associated model contract clause.

21. The system of claim 17 wherein the processor is further configured to identify one or more risk relationships for the contract under review based on at least one of the one or more the contract risk analytics, the contract risk score and the one or more contract clause risk scores.

22. The system of claim 17 wherein the processor is further configured to automatically generate one or more new contracts based on at least one of the one or more the contract risk analytics, the contract risk score and the one or more contract clause risk scores.

23. The system of claim 17 wherein the one or more contract risk analytic values comprises an identification of a given contract clause of the contract under review contributes the most to the contract risk score.

24. The system of claim 17 wherein the one or more contract risk analytic values comprises a risk ratio value, wherein the risk ratio value is a comparison of the contract value per the contract risk score of the contract under review to a contract value per a contract risk score of a second contract under review.
